(19) United States
(12) Patent Application Publication
(10) Pub. No.: US 2024/0037022 A1
(43) Pub. Date: Feb. 1, 2024

(54) METHOD AND SYSTEM FOR THE ANALYSIS OF TEST PROCEDURES

(71) Applicant: dSPACE GmbH, Paderborn (DE)

(72) Inventors: Robert TIMMERMANN, Paderborn (DE); Jan Hendrik HAMMER, Paderborn (DE); Christian GOERINGER, Paderborn (DE)

(73) Assignee: dSPACE GmbH, Paderborn (DE)

(21) Appl. No.: 18/216,936

(22) Filed: Jun. 30, 2023

(30) Foreign Application Priority Data
Aug. 1, 2022 (DE) 10 2022 119 220.2

(51) Int. Cl. G06F 11/36

(52) U.S. Cl. CPC G06F 11/3692; G06F 11/3664

(57) ABSTRACT

A method for the analysis of test procedures of a device and/or function for at least partially autonomous guidance of a motor vehicle, comprising aggregating of the first characteristic value calculated for each of the plurality of test cases to form a second characteristic value representing a meta-test case; and evaluating the second characteristic value using a specified second criterion and the logical linking of the first evaluation results of the plurality of test cases to a second evaluation result of the meta-test case. A system for the analysis of test procedures of a device and/or function for at least partially autonomous guidance of a motor vehicle is also provided.

This nonprovisional application claims priority under 35 U.S.C. § 119(a) to German Patent Application No. 10 2022 119 220.2, which was filed in Germany on Aug. 1, 2022, and which is herein incorporated by reference.

### BACKGROUND OF THE INVENTION

### Field of the Invention

The present invention relates to a computer-implemented method for the analysis of test procedures of a device and/or function for at least partially autonomous guidance of a motor vehicle. The present invention further relates to a system for the analysis of test procedures of a device and/or function for at least partially autonomous guidance of a motor vehicle. In addition, the invention relates to a computer program with program code to carry out the method according to the invention.

### Description of the Background Art

Driver assistance systems such as adaptive cruise control and/or functions for highly automated driving can be verified or validated using various verification methods.

For example, data replay testing or data playback testing can be used.

Data replay testing is an open-loop testing methodology based on the reproduction of recorded data sets at the interfaces of a system under test and the evaluation of the responses of the system under test against reference or ground truth data.

Such test methodology can be used on multiple test platforms, be it as software data replay or as hardware data replay.

The test starts with the definition of the requirements. In this phase, the scope of the data replay test campaign as well as success and failure criteria of the system under test, e.g., a percentage of positive object recognitions, are determined.

The results of the test are presented in a test report with all attached test result artifacts, such as the execution log data, including the test metadata. In addition, a preview tool allows for the debugging of tests if there is a test failure.

As a rule, however, test results can have a large number of test cases or test sequences, which are combined into logical test cases and these in turn into test suites.

This makes it difficult or inefficient for a user to evaluate test results. Moreover, the user is not only interested in finding out whether a tested vehicle function has successfully completed the test or not but is also interested in identifying the causes of errors.

Consequently, there is a need to improve existing test methods for the analysis of test procedures of a device and/or function for at least partially autonomous guidance of a motor vehicle in such a way that, on the one hand, tests can be efficiently assessed and, on the other hand, that a subset of sensor data comprising the identified errors can be tested in subsequent tests in order to enable more efficient test execution in the future.

### SUMMARY OF THE INVENTION

It is therefore an object of the present invention to provide a method and system for the analysis of test procedures of a device and/or function for at least partially autonomous guidance of a motor vehicle which enables simplified data evaluation as well as a more efficient test execution in the future using identified test errors.

According to an example of the invention, the object is achieved by a computer-implemented method for the analysis of test procedures of a device and/or function for at least partially autonomous guidance of a motor vehicle.

The object is further achieved by a system for the analysis of test procedures of a device and/or function for at least partially autonomous guidance of a motor vehicle.

The object is also further achieved by a computer program with program code for carrying out the method according to the invention.

The invention relates to a computer-implemented method for the analysis of test procedures of a device and/or function for at least partially autonomous guidance of a motor vehicle.

The method includes the provision of pre-recorded sensor data of a vehicle environment and/or vehicle-related parameters representing a plurality of test cases.

Furthermore, the method includes calculating at least one first characteristic value, i.e. a key performance indicator, which represents the performance of a tested device and/or function for at least partially autonomous guidance of the motor vehicle for each of the plurality of test cases, as well as evaluating the first characteristic value of each of the plurality of test cases using a specified first criterion to form a first evaluation result, i.e., so that the evaluation provides the first evaluation result.

The method also includes aggregating the first characteristic value calculated for each of the plurality of test cases into a second characteristic value representing a meta-test case, as well as evaluating the second characteristic value using a specified second criterion and logically linking the first evaluation results of the plurality of test cases to a second evaluation result of the meta-test case, i.e., so that the evaluation provides the second evaluation result.

The invention further relates to a system for the analysis of test procedures of a device and/or function for at least partially autonomous guidance of a motor vehicle.

The system comprises a data memory that is set up to provide pre-recorded sensor data of a vehicle environment and/or vehicle-related parameters representing a plurality of test cases.

The system also includes a calculation device, for example a computer, electronic control unit, etc., which is set up to calculate at least one first characteristic value representing the performance of a tested device and/or function for at least partial autonomous guidance of the motor vehicle for each of the plurality of test cases, as well as a first evaluation device which is set up to evaluate the first characteristic value of each of the plurality of test cases to form a first evaluation result using a specified first criterion.

Furthermore, the system includes an aggregation device which is set up to aggregate the first characteristic value calculated for each of the plurality of test cases into a second characteristic value representing a meta-test case, and a second evaluation device which is set up to evaluate the second characteristic value to form a second evaluation result of the meta-test case using a specified second criterion and the logical linking of the first evaluation results of the plurality of test cases.

The invention further relates to a computer program with program code to carry out the method according to the invention when the computer program is executed on a computer.

For example, the vehicle sensor may be a camera sensor, a radar sensor, a LiDAR sensor, an ultrasonic sensor, an infrared sensor, a tire pressure sensor, a wheel speed sensor, and/or a GNSS sensor, specifically a GPS sensor.

The function for at least partially autonomous guidance of a motor vehicle may be, for example, object recognition, adaptive cruise control, lane departure warning, active brake assist and/or park assist.

An error in the function for at least partially autonomous guidance of a motor vehicle exists, for example, if a bounding box was not set in accordance with an underlying requirement or a traffic sign was not recognized in the context of traffic sign recognition.

An idea of the present invention is to provide a characteristic value evaluating the test results of the level of concrete test cases by aggregating the first characteristic value calculated for each of the plurality of test cases to form a second characteristic value representing a meta-test case.

This gives the user the opportunity to identify more efficiently which of the plurality of test cases have not met the relevant test requirements.

By evaluating the second characteristic value using a specified second criterion and the logical linking of the first evaluation results of the plurality of test cases to form a second evaluation result of the meta-test case, it is also possible to assess whether the plurality of test cases have fulfilled the relevant test requirements in total or in aggregate.

On the basis of the above-mentioned evaluation at the level of the meta-test case, it can thus be advantageously made possible that a subset of the sensor data comprising the identified errors can be tested in subsequent tests. This, in turn, favors more efficient test procedures in the future.

The second characteristic can be calculated using a plurality of first characteristic values of each of the test cases and a normalization value assigned to each test case, in particular a distance traveled by the motor vehicle or a factor representing a distance traveled by the motor vehicle.

The normalization value advantageously ensures that the plurality of concrete test cases are evaluated to take into account the distance covered by the tested vehicle in each individual test case.

The second characteristic value can be calculated by minimum, maximum or median formation of the plurality of first characteristic values of each of the test cases and the standardization value assigned to each test case.

This makes it possible to identify, for example, which of the plurality of test cases have met the requirement and which of the plurality of test cases performed best and/or worst.

The first criterion can be specified by a first threshold, wherein the first characteristic value for each of the plurality of test cases is compared with the first threshold, and wherein a determination of a fulfillment or non-fulfillment of a requirement addressed to the device and/or function for at least partial autonomous guidance of the motor vehicle is made using a comparative result.

Thus, an objective evaluation of a requirement fulfillment of the device and/or function for at least partial autonomous guidance of the motor vehicle at the test case level can be made possible.

The second criterion can be specified by a second threshold, wherein the second characteristic value for the meta-test case is compared with the second threshold, and wherein a determination of a fulfillment or non-fulfillment of a requirement addressed to the meta-test case is made using a comparative result and the logical linking of the first evaluation result of the plurality of test cases.

Thus, an objective evaluation of the fulfillment of the requirements of the device and/or function for at least partial autonomous guidance of the motor vehicle can be made possible at the meta-test case level.

The meta-test case can represent a plurality of test cases of a similar nature, in particular test cases recorded under similar environmental conditions and/or similar traffic conditions.

Similar environmental conditions can be created, for example, by test drives or recordings at night, in rain, in backlight, etc. Similar traffic conditions can be created, for example, by highway driving, cross-country driving, city driving and/or trips with similar traffic volumes.

The meta-test case can thus advantageously comprise a plurality of concrete test cases that have been recorded under similar environmental conditions and/or similar traffic conditions.

The tested device and/or function for at least partial autonomous guidance of the motor vehicle can be object recognition and/or vehicle guidance. Thus, an evaluation of the performance of the tested device and/or function can be made possible in this way.

A third characteristic value can be calculated using a plurality of second characteristic values of each of the meta-test cases.

The third characteristic value can be based on a plurality of meta-test cases, in particular a test suite. This enables the evaluation of a requirement fulfillment of the meta-test cases included in the test suite.

A third criterion can be specified by a third threshold, wherein the third characteristic value for a test suite having a plurality of meta-test cases is compared with the third threshold, and wherein a determination of a fulfillment or non-fulfillment of a requirement addressed to the test suite is made using a comparative result and the logical linking of the second evaluation result of the plurality of meta-test cases.

Thus, an objective evaluation of the fulfillment of the requirements of the device and/or function for at least partial autonomous guidance of the motor vehicle can be made possible at the test suite level.

The first characteristic value can be determined by comparing ground truth data with the pre-recorded sensor data of the vehicle environment and/or vehicle-related parameters representing a plurality of test cases.

Thus, functions such as object recognition, the testing of which requires comparison with ground truth data, can be evaluated.

The first characteristic value of the pre-recorded sensor data of the vehicle environment and/or vehicle-related parameters representing a plurality of test cases can be determined with a fourth threshold.

In this way, aspects such as driving comfort, the testing of which requires a comparison of the measured values with a specified threshold, can be evaluated.

Each test case can have a plurality of test sequences, in particular individual images and/or measurement time series. Each of the individual images and/or measurement time series can be advantageously evaluated by means of a characteristic value.

A parameter space for a virtual test of the device and/or function for at least partially autonomous guidance of a motor vehicle can be determined using the evaluation of the second characteristic value of the plurality of test cases.

As a result, subsequent methods can be made to be more targeted and efficient, as they can be directed specifically at the identified test errors.

The features of the method described herein for the analysis of test procedures of a device and/or function for at least partially autonomous guidance of a motor vehicle are also applicable to the system of the present invention for the analysis of test procedures of a device and/or function for at least partially autonomous guidance of a motor vehicle, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a flowchart of a method for the analysis of test procedures of a device and/or function for at least partially autonomous guidance of a motor vehicle according to a preferred embodiment of the invention; and

FIG. 2 is a schematic representation of a system for the analysis of test procedures of a device and/or function for at least partially autonomous guidance of a motor vehicle according to the preferred embodiment of the invention.

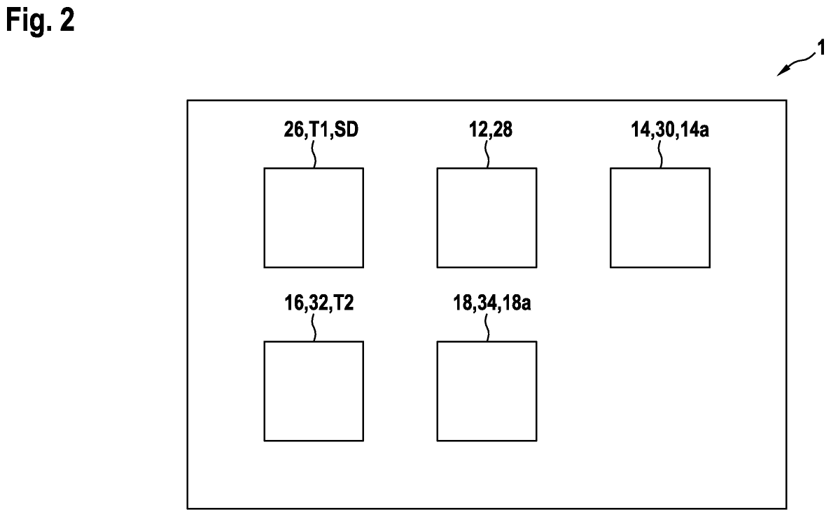

### DETAILED DESCRIPTION

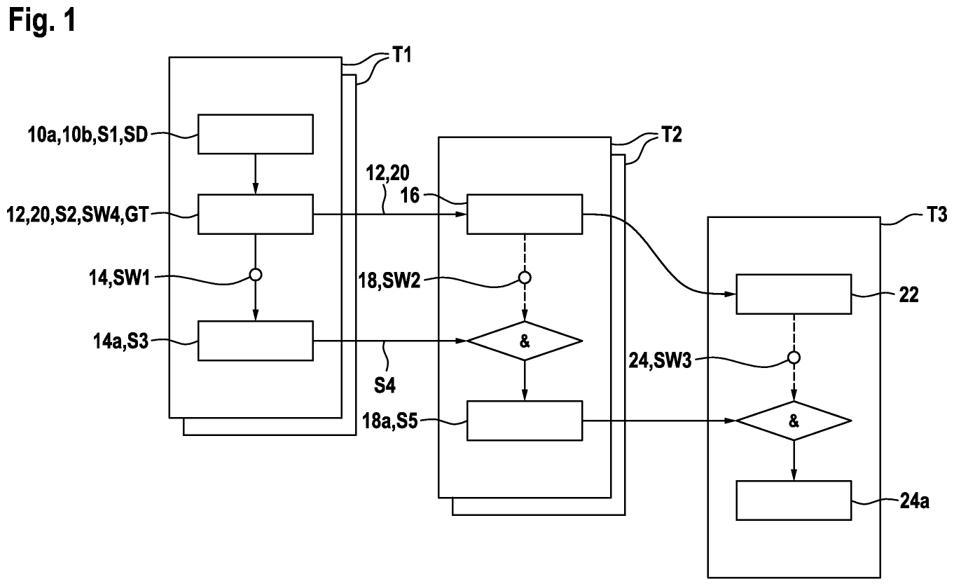

The method shown in FIG. 1 includes providing S1 pre-recorded sensor data SD representing a plurality of test cases T1, in particular a vehicle sensor of a vehicle environment and/or vehicle-related parameters.

Furthermore, the method comprises calculating S2 at least one first characteristic value 12 representing the performance of a tested device 10a and/or function 10b for at least partially autonomous guidance of the motor vehicle for each of the plurality of test cases T1, as well as evaluating S3 the first characteristic value 12 of each of the plurality of test cases T1 using a specified first criterion 14 to form a first evaluation result 14a.

In addition, the method includes aggregating S4 the first characteristic value 12 calculated for each of the plurality of test cases T1 into a second characteristic value 16 representing a meta-test case T2 and evaluating S5 the second characteristic value 16 using a specified second criterion 18 and the logical linking of the first evaluation results 14a of the plurality of test cases T1 to form a second evaluation result 18a of the meta-test case T2.

The second characteristic value 16 is calculated using a plurality of first characteristic values 12 for each of the test cases and a normalization value 20 assigned to each test case, in particular a distance traveled by the motor vehicle or a factor representing a distance traveled by the motor vehicle.

The second characteristic value 16 is further calculated by minimum, maximum or median formation of the plurality of first characteristic values 12 of each of the test cases and the normalization value 20 assigned to each test case.

The first criterion 14 is specified by a first threshold SW1. The first characteristic value 12 is compared with the first threshold SW1 for each of the plurality of test cases T1. A determination of a fulfillment or non-fulfillment of a requirement addressed to the device 10a and/or function 10b for at least partial autonomous guidance of the motor vehicle is made using a comparative result.

The second criterion 18 is specified by a second threshold SW2. The second characteristic value 16 is compared with the second threshold SW2 for the meta-test case T2. A determination of a fulfillment or non-fulfillment of a requirement addressed to the meta-test case T2 is made using a comparative result and the logical linking of the first evaluation result 14a of the plurality of test cases T1. The logical link is an AND link.

The meta-test case T2 represents a plurality of test cases T1 of a similar nature, in particular test cases recorded under similar environmental conditions and/or similar traffic conditions. The tested device 10a and/or function 10b for at least partially autonomous guidance of the motor vehicle is object recognition and/or vehicle guidance.

Alternatively, for example, other functions 10b and/or driving parameters such as driving comfort can be tested using measured data of a vertical acceleration, which is comparable to a reference value or threshold.

A third characteristic value 22 is calculated using a plurality of second characteristic values 16 of each of the meta-test cases. A third criterion 24 is specified by a third threshold SW3. The third characteristic value 22 is compared with the third threshold SW3 for a test suite T3 comprising a plurality of meta-test cases. A determination of a fulfillment or non-fulfillment of a requirement addressed to the test suite T3 is made using a comparative result and the logical linking of the second evaluation result 18a of the plurality of meta-test cases. This results in a third evaluation result 24a.

The first characteristic value 12 is further determined by comparing ground truth data GT with the pre-recorded sensor data SD of the vehicle environment and/or vehicle-related parameters representing a plurality of test cases T1.

Alternatively, the first characteristic value 12 of the pre-recorded sensor data SD of the vehicle environment and/or vehicle-related parameters representing a plurality of test cases T1 can be determined with a fourth threshold SW4.

Each test case comprises a plurality of test sequences, in particular individual images and/or measurement time series.

A parameter space for a virtual test of the device 10a and/or function 10b for at least partially autonomous guidance of a motor vehicle is further determined using the evaluation of the second characteristic value 16 of the plurality of test cases T1.

Although specific embodiments have been illustrated and described herein, it is understandable to those skilled in the art that a variety of alternative and/or equivalent implementations exist. It should be noted that the exemplary embodiment or exemplary embodiments are only examples and are not intended to limit the scope, applicability or configuration in any way.

Rather, the above-mentioned summary and detailed description provides the skilled person with convenient instructions for the implementation of at least one exemplary embodiment, it being understandable that various changes can be made in the range of functions and arrangement of the elements without deviating from the scope of the attached claims and their legal equivalents.

Generally, this application is intended to cover changes or adaptations or variations of the embodiments presented herein. For example, a sequence of the method steps can be changed. The method may also be carried out sequentially or in parallel, at least in sections.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for the analysis of test procedures of a device and/or a function for at least partially autonomous guidance of a motor vehicle, the method comprising:
providing pre-recorded sensor data of a vehicle environment and/or vehicle-related parameters representing a plurality of test cases;
calculating at least one first characteristic value representing a performance of a tested device and/or function for at least partial autonomous guidance of the motor vehicle for each of the plurality of test cases;
evaluating the first characteristic value of each of the plurality of test cases using a specified first criterion to form a first evaluation result;
aggregating the first characteristic value calculated for each of the plurality of test cases into a second characteristic value representing a meta-test case; and
evaluating the second characteristic value using a specified second criterion and a logical linking of the first evaluation results of the plurality of test cases to form a second evaluation result of the meta-test case.

2. The computer-implemented method according to claim 1, wherein the second characteristic value is calculated using a plurality of first characteristic values of each of the test cases and a normalization value assigned to each test case or a distance traveled by the motor vehicle or a factor representing a distance traveled by the motor vehicle.

3. The computer-implemented method according to claim 2, wherein the second characteristic value is calculated by minimum, maximum or median formation of the plurality of first characteristic values of each of the test cases and the normalization value assigned to each test case.

4. The computer-implemented method according to claim 1, wherein the first criterion is specified by a first threshold, wherein the first characteristic value is compared with the first threshold for each of the plurality of test cases, and wherein a determination of a fulfillment or non-fulfillment a requirement addressed to the device and/or function for at least partial autonomous guidance of the motor vehicle is made using a comparative result.

5. The computer-implemented method according to claim 1, wherein the second criterion is specified by a second threshold, wherein the second characteristic value for the meta-test case is compared with the second threshold, and wherein a determination of a fulfillment or non-fulfillment of a requirement addressed to the meta-test case is made using a comparative result and the logical linking of the first evaluation results of the plurality of test cases.

6. The computer-implemented method according to claim 1, wherein the meta-test case represents a plurality of test cases of a similar nature or represents test cases recorded under similar environmental conditions and/or similar traffic conditions.

7. The computer-implemented method according to claim 1, wherein the tested device and/or function for at least partially autonomous guidance of the motor vehicle is object recognition and/or vehicle guidance.

8. The computer-implemented method according to claim 1, wherein a third characteristic value is calculated using a plurality of second characteristic values of each of the meta-test cases.

9. The computer-implemented method according to claim 8, wherein a third criterion is specified by a third threshold, wherein the third characteristic value for a test suite comprising a plurality of meta-test cases is compared with the third threshold, and wherein a determination of a fulfillment or non-fulfillment of a requirement addressed to the test suite is made using a comparative result and the logical linking of the second evaluation results of the plurality of meta-test cases.

10. The computer-implemented method according to claim 1, wherein the first characteristic value is determined by comparing ground truth data with the pre-recorded sensor data of the vehicle environment and/or vehicle-related parameters representing a plurality of test cases.

11. The computer-implemented method according to claim 1, wherein the first characteristic value of the pre-recorded sensor data of the vehicle environment and/or vehicle-related parameters representing a plurality of test cases is determined with a fourth threshold.

12. The computer-implemented method according to claim 1, wherein each test case has a plurality of test sequences, individual images, and/or measurement time series.

13. The computer-implemented method according to claim 1, wherein a parameter space is determined for a virtual test of the device and/or function for at least partially autonomous guidance of a motor vehicle using the evaluation of the second characteristic value of the plurality of test cases.

14. A system to analyze test procedures of a device and/or a function for at least partial autonomous guidance of a motor vehicle, the system comprising:
a data memory to provide pre-recorded sensor data of a vehicle environment and/or vehicle-related parameters representing a plurality of test cases;
a calculation device to calculate at least one first characteristic value representing a performance of the tested device and/or function for at least partial autonomous guidance of the motor vehicle for each of the plurality of test cases;
a first evaluator to evaluate the first characteristic value of each of the plural test cases using a specified first criterion to form a first evaluation result;
an aggregator to aggregate the first characteristic value calculated for each of the plurality of test cases into a second characteristic value representing a meta-test case; and
a second evaluator to evaluate the second characteristic value using a specified second criterion and the logical linking of the first evaluation results of the plurality of test cases to form a second evaluation result of the meta-test case.

15. A computer program with program code to carry out the method according to claim 1 when the computer program is executed on a computer.

16. The computer-implemented method according to claim 1, wherein the at least one first characteristic value is a key performance indicator, which is a quantifiable measure of performance over time for a specific objective.
